(19) United States
(12) Patent Application Publication
(10) Pub. No.: US 2012/0328743 A1
(43) Pub. Date: Dec. 27, 2012

(54) Method and System for Powder Coating Particulate Ice Cream

(76) Inventors: Andy Head, Lexington, KY (US); Brian Shoop, Lexington, KY (US); Stan Jones, Vienna, IL (US)

(21) Appl. No.: 13/169,575

(22) Filed: Jun. 27, 2011

(51) Int. Cl. A23G 9/48; A23G 9/24

(52) U.S. Cl. 426/101; 426/295; 426/289

(57) ABSTRACT

The present invention relates to a composition comprising a powder coated particulate ice cream product, wherein the particulate ice cream product is cryogenically formed. The particulate ice cream product may further comprise a plurality of coatings including one or more powder coatings. The present invention further relates to methods for coating these cryogenically frozen ice cream particles.

### FIELD OF THE INVENTION

The present invention relates to ice cream food products and more particularly to cryogenically formed particulate ice cream.

### BACKGROUND

Ice cream products for human consumption are known to be popular. However, there is a market for ice cream products having an increased variety of flavors. There is also a need for decreasing the stickiness or adhesion of ice cream shapes. The need for these improvements is especially great with regards to particulate ice cream food products formed using cryogenically cooled equipment.

Not all ingredients of a coating can conveniently be added to an ice cream mixture before freezing (e.g., cryogenically freezing) takes place. For example, the acidity of some ingredients when mixed with the other ingredients of an ice cream formulation has a tendency to adversely affect the taste and texture of the dairy components. Thus, some combinations of flavors and ingredients have previously been unavailable in the form of particulate ice cream products.

### SUMMARY

Embodiments of the present invention relates generally to ice cream. In particular, the present invention relates to coated ice cream and methods of producing the same. Particulate ice cream compositions and methods of the invention find use in a variety of applications including increased shelf-life, free-flowing pourability, durability, flavor enhancement (including a wider variety of flavor options), texture enhancement and visual appeal of the compositions. It is described herein that coatings may be used to achieve these properties.

According to a first broad aspect of the present invention, a composition is provided comprising: a particulate ice cream food product; and a powder coating, wherein the particulate ice cream food product comprises a plurality of cryogenically frozen ice cream particles, and wherein the powder coating is disposed on the surface of the plurality of cryogenically frozen ice cream particles.

According to a second broad aspect of the present invention, a method is provided comprising the following steps: (a) providing a particulate ice cream food product, wherein the particulate ice cream food product comprises a plurality of cryogenically frozen ice cream particles; and (b) coating the surface of the plurality of cryogenically frozen ice cream particles with a powdered coating by agitation of the ice cream particles in the presence of the powdered coating.

According to a third broad aspect of the present invention, a method is provided comprising the following steps: (a) cryogenically freezing a particulate ice cream food product comprising a plurality of cryogenically frozen ice cream particles; and (b) coating the surface of the plurality of cryogenically frozen ice cream particles with a powdered coating.

It is understood that other embodiments of the present invention will become readily apparent to those skilled in the art from the following detailed description, wherein it is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF THE DRAWINGS

FIG. 1 depicts a flash freezing apparatus in accordance with the principles of the present invention.

FIG. 2 depicts a flowchart of an exemplary method of making a powder coated particulate ice cream product in accordance with the principles of the present invention.

### DETAILED DESCRIPTION

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

It is proposed herein that the variety of flavors of ice cream food products, particularly of small, cryogenically formed ice cream food particles or shapes, may be greatly increased by adding coatings, such as powder coatings, to these particulate ice cream food products. In addition, the stickiness or adhesion of these small particulate ice cream food products to one another may be reduced by the presence of a coating on their surface, and their free-flowing characteristic and/or pourability may be increased compared to uncoated ice cream food particles.

In accordance with embodiments of the present invention, these particulate ice cream food products may comprise formulations of frozen confections, such as ice cream, ice milk, flavored ices, sorbet, frozen yogurt, etc., in the form of small particulate shapes. Compositions and articles of the present invention may comprise one or more or a plurality of these small, cryogenically formed particles or shapes, which may be further coated, such as with a powder coating, as described herein.

These particulate ice cream food products of the present invention (prior to coating) may have a generally spherical or spheroid shape, but may also have an oblong, elliptical, oblate, tubular, or other slightly irregular shape. Their surface may also be either smooth or irregular (e.g., bumpy, pocked, etc.). On average, the ice cream food particles or shapes may have a diameter of about 0.05 inch to about 0.5 inch or less, including 0.4 inch, 0.3 inch, 0.25 inch, 0.2 inch, 0.15 inch, and about 0.1 inch, and ranges including and bordered by these dimensions. The particulate shapes having diameters outside these ranges (either greater than or less than) are also contemplated. For non-spherical shapes which do not have a conventional diameter, the diameter is the diameter of the smallest sphere into which the particulate shape would fit.

For purposes of the present invention, the terms “cryogenically formed” or “cryogenically frozen” refer to the flash freezing of a food product, such as a particulate ice cream food product, at very cold temperatures in the presence of a refrigerant, such as liquid nitrogen or nitrogen vapor, (typically inside an enclosure or chamber). A “cryogenically formed” or “cryogenically frozen” food product may at least initially be nearly instantaneously or quickly frozen into a glass state by vitrification. The “cryogenically formed” or “cryogenically frozen” food product may then undergo a glass transition, devitrification and/or melting if warmed.

The particulate product of the present invention (sometimes referred to as “beads”) is generally in the form of a plurality of free-flowing ice cream food particles that are readily pourable. “Free-flowing,” as used herein, is a broad term which includes the ability of the product to flow as individual particles, with little or no clumping or sticking to each other, during such pouring. There may be slight sticking after a period of storage, but a light tap on the container will unstick the particulate shapes and allow them to be free-flowing. The generally spherical shape helps contribute to the free-flowing, pourable product.

It is further proposed herein that the free-flowing character or pourability of the product may be increased at a given temperature and formulation by coating the surface of the individual food particles or shapes with a powder. A given formulation of coated or uncoated ice cream particles or beads will have a critical adhesion temperature (or temperature range), above which the discrete ice cream particles (sometimes referred to as “centers” in the case of coated particles or products) will begin to agglomerate. Typically for uncoated cryogenically frozen ice cream particles or shapes, this temperature may be from about −20° F. to about 0° F., depending on time scale and temperature history. The coating applied to the particle or center may effectively shield the particles or “centers,” which have relatively low critical adhesion temperatures, by coating with a powder having a relatively high critical adhesion temperature.

Unlike traditional ice cream, cryogenically frozen ice cream particles may not be stable in standard home and grocery freezers and are not capable of reversible melting (i.e., capable of being refrozen back into an identical or similar state). Due to a lack of overrun of the cryogenically formed ice cream results in irreversible adhesion of particles and macrostructure breakdown and phase separation upon melting. Therefore, it is important that the cryogenically formed ice cream particles or beads be kept at sufficiently cold temperatures once made to maintain their free-flowing pourability.

To maintain their pourability and free-flowing character and to reduce or eliminate their stickiness or adhesion to each other, the cryogenically formed particulate ice cream food products of the present invention may be stored in a specialized, low temperature freezer preferably having a temperature averaging from about −20° F. to about −40° F. In other embodiments, the particulate products may be stored at higher temperatures, such as in a home freezer or in a grocery dairy freezer and maintain a free-flowing form while being stored at a temperature between about −10° F. and 0° F. with an occasional rise to perhaps as much as +5° F. One way to accomplish this, for example, may be to increase the freezing point (reduce the freeze-point depression) of the liquid formulation that forms the particulate shapes, although other ways may also be used. Exemplary formulations that remain free-flowing at higher temperatures are described in U.S. patent application Ser. Nos. 11/701,624 and 11/801,049, the disclosures of which are incorporated by reference herein in their entireties.

Storage conditions are described further below, and the preservation and/or maintenance of the free-flowing character of the particulate ice cream food product may be further enhanced at a given temperature and formulation by the presence of a coating, such as a powder coating, on the surface of at least some of the ice cream food particles.

According to embodiments of the present invention, the formulation of the particulate ice cream food products of the present invention may comprise either high-temperature or low-temperature formulations prior to coating. The formulation may comprise the following ranges of components (all percentages are weight percentages): (i) 0% to about 16% milkfat (optional), or alternatively, about 1% to about 16% milkfat, or alternatively, about 6% to about 14% milkfat; (ii) about 2% to about 24% serum or non-fat milk solids, or alternatively, about 4% to about 24% serum or non-fat milk solids; and (iii) 0% to about 8% sugar (optional), or alternatively, about 1% to about 8% sugar (e.g., sucrose, etc.). The amount of sugar may be adjusted and may be optional especially with the addition of other sweeteners. According to some embodiments, the formulation of the particulate ice cream food products of the present invention may further comprise one or more of the following ranges of components (all percentages are weight percentages): (iv) about 0.1% to about 0.4% sweetener; (v) about 1% to about 20% bulking agent; (vi) about 0.1% to about 1% cryoprotectant; (vii) about 0.3% to about 4% stabilizer and/or emulsifier; and/or (viii) varying amounts of one or more natural and/or artificial flavors.

In the United States, the total solids content must be 35.55% to legally describe a product as ice cream. This is because most ice creams finished ice cream product must weigh at least 4.5 lb/gal and must contain at least 1.6 lb of food solids or total solids per gallon, which essentially equates to a minimum total food solids of 35.5%. In the USA, any finished product below these limits cannot be labeled ice cream. However, other countries have different requirements. For example, in several countries other than the U.S. the total solids content of a formulation can be as low as 29.7%, and possibly lower, yet still be labeled ice cream. All formulations should include a solids component, and the total solids percentage plus water percentage should equal 100%. Thus, for example, if the total solids content of a formulation rises, it is to be understood that the water content would be reduced accordingly.

Accordingly, formulations of the particulate ice cream food products according to embodiments of the present invention (prior to coating) may comprise at least about 29% by weight total solids and less than about 71% by weight water, or alternatively, formulations of the present invention (prior to coating) may be at least about 35% by weight total solids and less than about 65% by weight water. According to some embodiments, the total solids in a frozen confection is at least about 25%, at least about 26%, at least about 26.5%, at least about 27%, at least about 27.5%, at least about 28%, at least about 28.5%, at least about 29%, at least about 30%, at least about 31%, at least about 32%, at least about 33%, at least about 34%, at least about 35%, at least about 36%, or at least about 37%, wherein the stated percentages are by weight of the weight of the total formulation including water. However, each of the above percentage ranges may also be bounded on the upper end by a maximum of about 42% total solids.

Particulate ice cream food products according to embodiments of the present invention may comprise either dairy or non-dairy formulations. Milkfat, also called butterfat, in the composition provides much of the creamy texture and body to the formulation, with higher levels providing greater creaminess and richness. Serum solids or nonfat milk solids are those components of milk and/or cream which are water soluble, including but not limited to caseins and other milk proteins. It is to be noted that although milkfat and water are listed as separate ingredients, milkfat, water and serum solids may be included in the milks and creams that form the basis of the formulations, and thus may not necessarily comprise separate ingredients.

Nonfat milk solids enhance the texture of ice cream, aid in giving body and chew resistance, and may be less expensive than milkfat. Whey solids, including modified whey products, may also be substituted for nonfat milk solids, but under USA federal government requirements, not for more than 25% of the total nonfat milk solids in the overall formulation. Egg yolk can also be used as another source of solids. According to some embodiments, about 1% to 25%, including 5% to 20% and 10% to 15% of the nonfat milk solids in a formulation may comprise whey solids and/or egg yolk solids.

Emulsifiers may be included within the various formulations, especially those containing milkfat. Preferred emulsifiers may include monoglycerides, diglycerides, and polysorbates. Stabilizers may be included within the various formulations. Stabilizers assist in controlling the viscosity of the formulations, with more stabilizer generally providing increased viscosity, especially in those embodiments having lower amounts of fats and solids. The viscosity affects the drip rate of the formulation. Stabilizers may include guar, carrageenan, cellulose gum, LBG, and/or CMC. With non-dairy formulations, stabilizers may play an important role. Among other functions, stabilizers may absorb free water sometimes present within an ice cream product formulation. One stabilizer that may effectively serve this purpose is cellulose gum, although many other stabilizers may be used.

In those dairy embodiments where both stabilizers and emulsifiers are used, the combined stabilizer/emulsifier need not actually be added as a single ingredient when making the formulation; the weights of these two materials are included together because in many embodiments, commercial combined stabilizer/emulsifier formulations are used, which include one or more stabilizers and one or more emulsifiers. Accordingly, the stabilizer/emulsifier may be a commercial or proprietary formulation or it may be a combination or series of one or more stabilizers and/or one or more emulsifiers added to the formulation.

One or more bulking agents may also be added to formulations according to certain embodiments. Bulking agents include high molecular weight polymeric compounds (such as polysaccharides), which add viscosity and bulk to foods. Preferred bulking agents include, but are not limited to polydextrose, dextrans, corn syrup solids, and maltodextrins. In certain preferred embodiments, maltodextrins are used, including, but not limited to, those having a DE of 5, 10, 15, and 20, where DE refers to “dextrose equivalent.” Because bulking agents and stabilizers both contribute to the viscosity of a formulation, formulations containing a bulking agent may or may not include a stabilizer or stabilizer/emulsifier.

Formulations of the present invention may include at least some sugar (e.g., sucrose, etc.). Sugar may be present at 1-17% by weight, including 1-8%, 5-15%, 2-8%, about 3%, 4%, 5%, 6%, 7%, 8%, 9%, 10%, 11%, 12%, and 13% and ranges encompassing and bounded by these values. Formulations may also include lactose, as it is a natural part of milk, cream, and nonfat milk solids.

Formulations of the present invention may include other non-sugar sweeteners in the formulation such as fructose, artificial sweeteners including, but not limited to, sucralose, aspartame, and saccharine, rebaudioside A (Rebiana) and combinations of one or more sweeteners. Because artificial sweeteners are much sweeter than sugar for a given weight (sucralose is about 600 times sweeter than sugar) their amounts may be much less. The amount of sucralose, for example, may be very small (e.g., 0.01-0.4% by weight, if present, including about 0.015, 0.02, 0.03, 0.04, 0.05, 0.1, 0.15, 0.2, 0.3 and ranges encompassing and bounded by these values) yet still have effective sweetness. Accordingly, the substitution of artificial sweeteners for sugar can reduce the amount of solids and sucrose in the formulation. Of the artificial sweeteners, sucralose has an advantage of remaining stable during homogenization/pasteurization. Other non-sugar sweeteners have similar properties.

The formulations may also include one or more flavorings. These include but are not limited to chocolate, strawberry, vanilla, and banana split. The amount of flavoring added is usually somewhat small, such that differences in composition are relatively minute such that the flavoring does not substantially affect the storability characteristics of the particulate shapes formed from the various formulations. It should be noted, however, that some flavorings, such as chocolate, may require the presence of additional sweeteners over what is necessary for other flavorings (e.g., vanilla). In the case of chocolate, additional sugar or sweetener, such as corn syrup solids or other sweetener, may be added in excess of the amount that would be present normally to provide additional sweetness that is of benefit with the cocoa powder added for flavoring. For example, about 0.5% to 2%, including about 1% and 1.5%, of additional sugar or sweetener may be used with chocolate.

Stabilizing agents are also used to give texture, body, stiffness and alter the melting properties of the ice products described herein. These are especially important in particulate ice cream products, because forming the particulate shapes in a spherical or similar shape and the resulting free-flowing properties generated therefrom are beneficial to the commercial success of the product. The stabilizers may accomplish this by binding up water that has melted due to temperature fluctuations, thus preventing that water from diffusing throughout the entire formulation and forming larger ice crystals upon refreezing.

Formulations may also include a cryoprotectant, including but not limited to ice structure proteins and propylene glycol monostearate, to preserve small crystal size and maintain the product during shipping and storage. These materials may be optionally included in a formulation.

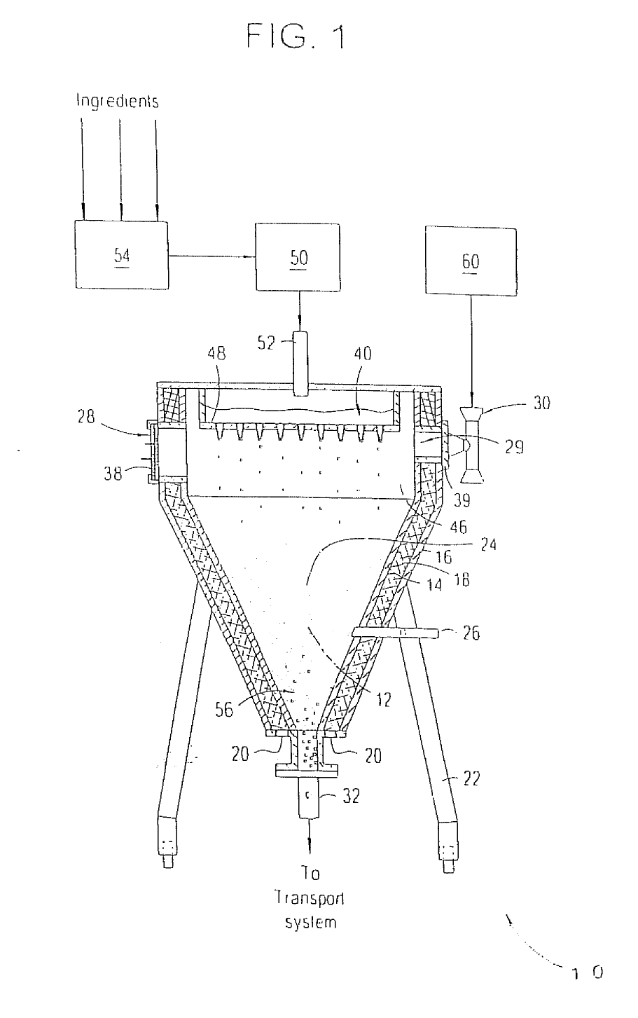

FIG. 1 shows an exemplary cryogenic processor constructed to produce free-flowing particulate ice cream products or beads 56. The fundamental method utilized to produce the product is described in detail in U.S. Pat. No. 5,126,156, which is hereby incorporated by reference in its entirety. A cryogenic processor 10 includes a freezing chamber 12 that is in the form of a conical tank that holds a liquid refrigerant therein. A freezing chamber 12 incorporates an inner shell 14 and an outer shell 16. Insulation 18 is disposed between the inner shell 14 and outer shell 16 in order to increase the thermal efficiency of the chamber 12. Vents 20 are also provided to ventilate the insulated area formed between the shells 14 and 16. The freezing chamber 12 is a free-standing unit supported by legs 22.

A refrigerant 24, preferably liquid nitrogen, enters the freezing chamber 12 by means of refrigerant inlet 26. The refrigerant 24 is introduced into a chamber 12 through the inlet 26 in order to maintain a predetermined level of liquid refrigerant in the freezing chamber because some refrigerant 24 can be lost by evaporation or by other means incidental to production. Gaseous refrigerant that has evaporated from the surface of the liquid refrigerant 24 in freezing chamber 12 primarily vents to the atmosphere through exit port 29 which cooperates with the vacuum assembly 30, which can be in the form of a venturi nozzle. Extraction of the frozen particulate beads occurs through product outlet 32 adapted at the base of the freezing chamber 12.

An ambient air inlet port 28 with adjustment doors 38 and exit port 29 with adjustment doors 39 are provided to adjust the level of gaseous refrigerant which evaporates from the surface of the liquid refrigerant 24 so that excessive pressure is not built up within the processor 10 and freezing of the liquid composition in the feed assembly 40 does not occur.

A feed tray 48 receives liquid composition from a delivery source 50. Typically, a pump (not shown) drives the liquid composition through a delivery tube 52 into the feed tray 48. A premixing device 54 allows several compositions, not all of which must be liquid, such as powdered flavorings or other additives of a size small enough not to cause clogging in the feed assembly 40, to be mixed in predetermined concentrations for delivery to the feed tray 48.

In order to create uniformly sized particles or beads 56 of the frozen particulate ice cream product, uniformly sized droplets 58 of liquid composition may be fed through gas diffusion chamber 46 to freezing chamber 12. The feed tray 48 may be designed with feed assembly 40 that forms droplets 58 of the desired character. The frozen product takes the form of beads that are formed when the droplets 58 of liquid composition cryogenically “flash freeze” in contact with the refrigerant vapor in the gas diffusion chamber 46, and subsequently the liquid refrigerant 24 in the freezing chamber 12. After the beads 56 are formed, they fall or are mechanically directed to the bottom of chamber 12. A transport system connects to the bottom of chamber 12 at outlet 32 to carry the beads 56 to later processing steps and, ultimately, to a packaging and distribution network for later delivery and consumption.

The vacuum assembly 30 cooperates with air inlet 28 and adjustment doors 38 so that ambient air flows through the inlet and around feed assembly 40 to ensure that no liquid composition freezes therein. This is accomplished by mounting the vacuum assembly 30 and air inlet 28 on opposing sides of the gas diffusion chamber 46 such that the incoming ambient air drawn by the vacuum assembly 30 is aligned with the feed assembly. In this configuration, ambient air flows around the feed assembly warming it to a sufficient temperature to inhibit the formation of frozen liquid composition in the feed assembly flow channels. An air source 60, typically in the form of an air compressor, is attached to vacuum assembly 30 to provide appropriate suction to create the ambient air flow required.

Small particulate ice cream products of the present invention after being cryogenically formed may generally be stored at sufficiently low temperatures, such as in very low temperatures of specialized or cryogenic freezers, to maintain the free-flowing characteristic and pourability of the particulate ice cream product over time. In certain embodiments, the product may be capable of being stored at higher temperatures, such as in a freezer at temperatures that are commonly used to store conventional ice cream and frozen foods, while maintaining the properties of the particulate shapes being substantially free-flowing and pourable at least for a period of time. This may be achieved, for example, by using higher temperature formulations as described or incorporated above. In general, the ability to store a particulate ice cream food product of the present invention for a given period of time may be dependent on temperature and formulation. The higher the storage temperature for any given formulation, the less time the product can be stored while (i) avoiding stickiness or adhesion of the particles or beads and (ii) maintaining their free-flowing characteristic and pourability.

Several factors and properties may affect the stability and performance of the particulate ice cream products of the present invention in storage at a given temperature. One property is the freezing point of the formulation. Formulations having a higher freezing point are able to remain more firmly frozen at higher freezer temperatures, which contributes positively to the product remaining free-flowing. One way to increase the freeze point of a formulation is to decrease the amount of low molecular weight compounds, which contribute to freezing point depression, with or without modifying the total solids of the formulation. According to some embodiments, the amount of small saccharides may be reduced or minimized.

Although a formulation having the highest freeze point might be considered to have the highest storage temperature, this is not necessarily the case. This is because there are many factors that affect storage stability, such as glass transition, presence or absence of devitrification, amount of free water present at the storage temperature, and/or onset of melting for any given formulation.

Because the rate that stickiness or clumping of the particles occurs is also dependent upon the ability of the water molecules to move freely within the formulation matrix to form crystals, another way of reducing the rate of crystal formation is to create a more viscous formulation matrix. This can be done by reducing the amount of small molecules in a formulation as mentioned and/or increasing the amount of large molecules in a formulation. For example, the amount of sucrose can be reduced, and/or milk products with reduced lactose can be used. Larger molecules, including but not limited to bulking agents such as maltodextrins, can be added to the formulation.

Although not wishing to be bound by theory, it is believed that another factor that contributes to sticking of the particles is the amount of free (non-crystalline) water present in the formulation. Among two formulations having equal amounts of total water but different proportions of ice to free water (due to differences in formulation) are stored in identical conditions, it is postulated that the formulation having the higher percentage of free water will tend to have particles that stick together more (and sooner) than the formulation having more of its water bound up in crystals as ice. The amount of free water in a formulation at a given temperature depends upon the temperature of the onset of melting. Accordingly, the amount of free water in some formulations at 0° F. may be about 0.1% to 16% of the water in the formulation, including about 5% to 15%, 7%-11%, and 7%, 8%, 9%, 10%, 11%, 12%, 13%, 14%, and 15% and ranges encompassing and bounded by these values.

Other properties of present formulations that may affect the properties of the product at higher temperatures may include the glass transition and devitrification temperatures of the product formulation. These transitional temperatures for any formulation may be predicted and/or determined using various techniques, such as microscopy (e.g., electron microscopy), calorimetry, etc.

Initially, when the beaded or particulate product is formed, a small amount of the formulation is flash frozen in the presence of the refrigerant such that the product becomes a food glass in which the molecules of the formulation are in an arrested state of motion such that they cannot organize into a crystalline structure even though the formulation is at a temperature well below the freezing point. This glassy form is characterized by the molecules being disordered and the material is brittle and somewhat unstable. As this material is warmed, it surpasses or goes through its glass transition. At the glass transition temperature, molecules in the formulation begin to break free such that the material transitions from the glassy state into a material that is rubbery or plasticized. For example, formulations according to embodiments of the present invention may have a glass transition temperature (midpoint) of at least −55° F., such as at about −53° F., or alternatively at about −50° F. or higher, about −45° F. or higher, about −40° F. or higher, about −35° F. or higher, about −25° F. or higher, about −20° F. or higher, about −15° F. or higher, about −10° F. or higher, about −5° F. or higher, or about 0° F. or higher, (prior to coating) as well as any range encompassing and bounded by these values.

If the material is allowed to continue to warm to a slightly higher temperature, it will eventually reach the temperature at which devitrification might occur. Devitrification is the process of ice formation during heating. Many factors and variables may contribute to vitrification/devitrification (transition into/out of glassy state respectively), some of which are sucrose level, protein content and source, stabilizers, maltodextrins, and storage temperature. With regard to devitrification and ice crystal formation, there are several considerations. Two considerations are the temperature at which devitrification occurs and the magnitude of the exotherm during ice formation which may depend on the annealing time. For example, according to an embodiment where the glass transition temperature of a formulation prior to coating is about −53° F., the devitrification temperature of a formulation may be about −52° F.

Another property that may affect the properties of frozen particulate ice cream products at higher storage temperatures is the ice crystal size. As discussed above, the formulation is frozen very rapidly (sometimes referred to as flash-freezing), such as in the presence of a refrigerant. The rate at which the droplets of the formulation are frozen into particulate shapes is very rapid, with the complete freezing process being completed within less than two minutes. Because of this, and provided that the formulation is not allowed to be at higher temperatures (i.e., above the melting point or devitrification point) for extended periods of time, the ice crystals formed therein are much smaller than if the formulation were frozen more slowly. This is a desired feature. Large ice crystals can cause the particulate shapes to be perceived as coarse and less palatable.

According to embodiments of the present invention, the cryogenically frozen particulate ice cream product comprising a plurality of ice cream particles may be stored at a sufficiently low temperature, such that its free-flowing characteristic and pourability are maintained over a substantial length of time, such as over a period of days, weeks or months. Such a storage temperature may be at or below (or not well above) one or more of the following: glass transition temperature, devitrification/freezing temperature, and/or melting temperature for the flash frozen formulation. For example, the particulate ice cream product may be stored relatively long term within the following ranges: about −40° F. to about −10° F.; or about −40° F. to about −20° F.; or about −30° F. to about −10° F.; or about −20° F. to about −10° F.; or about −20° F. to about 0° F.; or about −10° F. to about 0° F. or about −10° F. to about 5° F.; or any other range encompassed and bounded by these values. For example, the particulate ice cream product may be stored at about −40° F., about −30° F. or about −20° F.

According to some embodiments, the particulate ice cream product prior to coating may be stored at these temperatures while maintaining its free-flowing pourability for a period of at least hours or days depending on temperature and formulation. For example, some formulations may be stored at −25° F. for a period of many hours (e.g., 24 hours) while maintaining their free-flowing character and pourability. Formulations may also be stored at −30° F. for a period of several days (e.g., greater than 48 hours) while maintaining their free-flowing character and pourability.

According to embodiments of the present invention, the cryogenically frozen particulate ice cream food product comprising a plurality of small ice cream food particles, beads or shapes may be combined with one or more coatings, such as a powder coating, disposed on the surface of these particles. These powder coatings may be used to provide additional flavors, appearance or mouth feel for the particulate ice cream food product. Powder coatings may also be used to reduce or eliminate the stickiness, clumping or adhesion of the individual ice cream particles to one another at a given formulation and temperature to thus maintain the free-flowing pourability of the product.

While almost any powder coating is contemplated within the scope of the present invention, some exemplary coatings are identified below as having particular benefits when combined with the cryogenically formed particulate ice cream products. The discussion of these example coatings is not intended to limit the present invention to only applying these particular powder coatings. In addition to powder coatings, other coatings may be applied such as fats, oils, butter, clarified butter, cocoa butter, chocolate, beeswax, carnauba wax, and the like, which may optionally be used in combination with powder coatings. The consistency, viscosity, particle size, melting point, moisture content and similar physical characteristics of the coating material may help determine what delivery method is optimal for apply the coating material to the particulate ice cream. Similarly, fish oil or other coatings that have beneficial fats are further contemplated. Alternatively, some fats or oils may be applied as a powder under some circumstances, and some oils may be spray-dried or microencapsulated when applied to the particulate ice cream.

For powder coatings, the powder may bond to the frozen particulate ice cream as the particles/beads and the powder are mechanically agitated, for example, to continually place them in contact with one another, which may be achieved using any technique or suitable apparatus, such as by agitation, vibration, tumbling, shaking, etc. The mechanism of bonding the powder to the particulate ice cream product may be due to any mechanical, chemical, ionic, intermolecular, hydrogen, or other form of bonding, or various combinations thereof.

The present invention is generally not limited by the size of the individual powder granule diameter. In some embodiments, the individual power granule diameter may be about 100 μm, 150 μm, 200 μm, 250 μm, 300 μm, 350 μm, 400 μm, 450 μm, 500 μm, 550 μM, 600 μm, 650 μm, 700 μm, 750 μm, 800 μm or greater (or any other range encompassed and bounded by these values). In a preferred embodiment, the individual powder granules may be smaller in size and more uniform in shape. Smaller and more uniform granules provide increased surface coverage of the ice cream particles. With embodiments of the invention where a thick coating is desired, multiple layers of coating may be necessary.

According to some embodiments, a powder coating comprising citric acid may be used. If citric acid were mixed with a typical dairy blend used in making ice cream, the acid would likely curdle the dairy components in that blend. As a powder coating, however, the citric acid may be combined with the particulate ice cream in amounts that produce desirable tart and sour flavor sensations. In this way, flavors may be combined with the particulate ice cream in flavor combinations that were previously unachievable, such as orange flavor coating vanilla ice cream particles and sour cherry flavor coating chocolate ice cream.

According to other embodiments, the powder coating may comprise a probiotic coating that includes beneficial bacteria and yeast usually attributed to yogurt. Accordingly, some of the healthful benefits of yogurt may be attained while enjoying an ice cream dessert.

According to other embodiments, a powder coating may comprise coffee solids, cocoa powder, sugars (e.g., granulated and powdered sucrose, dextrose, fructose, etc.), non-nutritive sweeteners (e.g., sucralose, aspartame, etc.), polysaccharides (e.g., maltodextrin, gum, pectin, starch, etc.), silicon-based solids (e.g., SiO₂ or SIPERNAT®), powdered proteins (e.g., whey protein, zein protein, etc.) and the like (with optionally added flavor components if desired). According to other embodiments, the powder may even be unflavored and simply used for producing the visual effect of having ice cream particulates with different inner and outer colors. When flavored powders are used, the formulation of the ice cream itself may be modified to produce a desired flavor combination. For example, if sucrose is used, then the sugar content of the ice cream formulation may be reduced.

Since the particulate ice cream food product of the present invention is generally served at very cold temperatures (e.g., about −40° F. to about 0° F.), embodiments including the powder coating may provide enhanced flavor delivery. Food products that are cold and which cool the inside of the mouth suppress flavor perception. By surrounding particulate ice cream with a flavorful coating, the coating portion is warmed in the mouth faster than the particulate ice cream portion even though both are being served at the same temperature. Thus, when embodiments of the present invention are consumed, the flavor of the coating is perceived to be stronger than if such flavor where simply an ingredient of the particulate ice cream formulation itself.

In addition to providing additional flavor combinations and mouth sensation and feel, application of a powder coating to a cryogenically formed particulate ice cream product may also (or separately) be used, for example, to (i) reduce the water migration around the nucleated surface thereby improving the texture and shelf life of the product, (ii) allow the separate ice cream particles or beads to free-flow more easily and at higher temperatures, and/or (iii) provide visually appealing beads that have varying colors, textures, tastes, and layers. The coated ice cream particles or beads may also be used in combination with uncoated particles or beads so as to aid in providing a free-flowing character to the combined particles or beads. Particulate ice cream food products formed according to embodiments of the present invention having a powder coating applied to the surface thereof may have an improved free-flowing character and pourability compared to an uncoated product: the coated particulate shapes may be more spherical, their surface may be harder and smoother, and their surface area per volume ratio may be reduced, thereby reducing overall contact area.

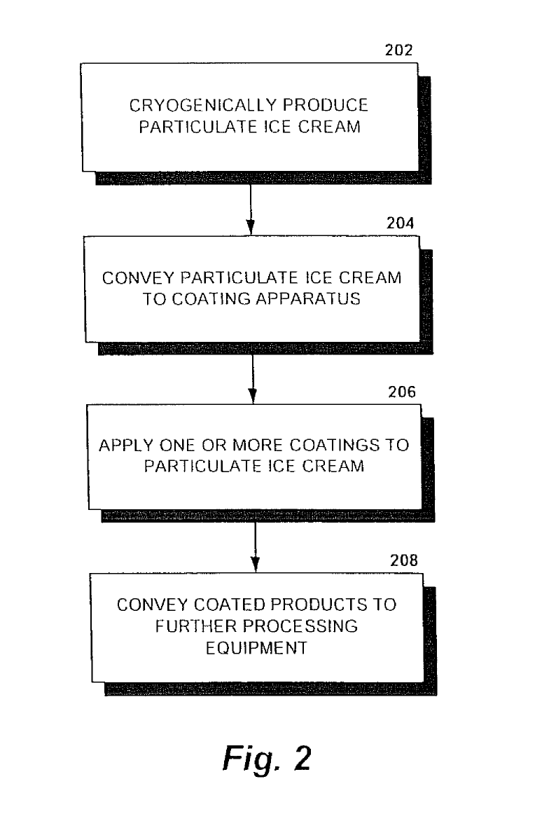

FIG. 2 depicts a flowchart of an exemplary method for coating the cryogenically frozen ice cream food particles or beads with one or more powders in accordance with the principles of the present invention. In step 202, the particulate ice cream is cryogenically formed such as by the process and apparatus described above, for example, with respect to FIG. 1. However, one of ordinary skill will recognize that the particulate ice cream product may be cryogenically made by a different method and apparatus. Any such apparatuses or methods are also contemplated within the scope of the present invention.

In step 204 in FIG. 2, the particulate ice cream product is conveyed, transported or otherwise transferred by any active or passive means to a coating apparatus. Such conveyance or transfer to the coating apparatus may be accomplished, for example, using cryogenically cooled conveyors so as to maintain the particulate ice cream at a low temperature. However, many types of coatings, including powder coatings, have difficulty being uniformly applied at temperatures where the ice cream is solid or semi-solid (e.g., at the cold temperatures used for long term storage and/or glass transition or vitrification). As a result, coated particulate ice cream products may sometimes be produced at these temperatures which are unintentionally less appealing in either taste, texture or appearance.

According to some embodiments, therefore, the particulate ice cream product may instead be allowed to rise or warm somewhat during the conveying step in preparation for coating from the usual storage temperature (within a range of about −40° F. to about −20° F.) to a higher desired temperature (e.g., to a temperature within a range of at least about −20° F. to about 5° F. or higher for a limited period of time) prior to and/or during the coating step. This may be achieved according to some embodiments by using conveyors at a desired temperature for conveyance of the particulate ice cream product to the coating apparatus. These higher temperatures may be used to enhance the adherence or binding of a coating, such as a powder coating, to the individual cryogenically frozen particulate ice cream particles or beads, which may be uncoated or coated when multiple coatings are applied. The conveyance or transfer of the particulate ice cream may be accomplished in a continuous production stream or the ice cream particles or beads may be collected in bulk, which may then be bulk transferred to the coating apparatus.

Once the particulate ice cream is delivered to the coating apparatus, one or more coatings are applied to the particulate ice cream in step 206 of FIG. 2. One exemplary coating apparatus is described in detail in U.S. patent application Ser. No. 11/891,756 hereby incorporated by reference in its entirety. One embodiment of a coating apparatus described therein includes a rotating drum in which particulate ice cream is coated by using an aerosolized spray while being tumbled or by mechanical tumbling alone (e.g., using a powder coating as a pre-treatment or substitute for an aerosolized spray). However, coating may be achieved using any suitable technique, apparatus or means, such as by agitation, turbulence, vibration, tumbling, shaking, etc. To keep the ice cream particles from getting too warm during the coating step, cooling of the equipment may be carried out by bathing or jacketing the coating chamber with chemical refrigerant such as liquid nitrogen or dry ice or a mechanically cooled refrigerant such as brine, glycol, or water.

According to some embodiments, the coating step may be carried out at a temperature higher than the usual storage temperatures, such as within a range of at least about −20° F. to about 5° F. or higher, such as by controlling or affecting the temperature of a coating apparatus. In those circumstances wherein the coating step is performed at a slightly higher temperature, the coating step may be carried out for a limited period of time (e.g., in a range from about 1 minute to about 30 minutes, such as from about 10 minutes to about 20 minutes) to achieve sufficient coating while avoiding or minimizing melting or breakdown of the product. The appropriate length of coating time at a given temperature and ice cream formulation may depend on the size of the powder granules and the desired evenness and thickness of the coating. Generally, longer periods of time are appropriate for coarser powder granules and for more even application of the powder on the surface of the ice cream particles. However, tighter temperature control may become increasingly important with longer coating times.

During or prior to the coating step, the powder may be applied at a desired rate while tumbling the particulate ice cream, or the powder may be added all at once and/or in an excess amount before tumbling commences and/or during tumbling. The particulate ice cream may also be powder coated in discrete steps such that powder coating is added, the product is tumbled, more coating is added, and then the product is tumbled more. The amount of powder, the temperature of the product, the grain size of the powder, the speed of tumbling, the adherence properties of the coating, the moisture content of the coating, and the duration of tumbling can all be controlled to produce a particulate ice cream product that has a powder coating with a desired thickness, texture, and flavor.

Although the application of a single powder has been discussed, alternative embodiments of the present invention contemplate the application of more than one coating to the particulate ice cream as well. For example, coated ice cream particles may be retrieved from one coating apparatus and then introduced into a second coating apparatus so that the two coatings may be sequentially applied to the ice cream particles. An optional re-freezing step may be used to ensure the ice cream particles or beads are at a desired temperature before receiving a second coating. Alternatively, a coating apparatus may be provisioned with two or more powder coating delivery means that are connected to their own respective coating materials, and different coatings may be applied sequentially from each of the delivery means so that the resulting product will have multiple layers of coating. Furthermore, in an embodiment having multiple delivery means with a coating apparatus, compound powder coatings having more than one component may be applied such that each component is applied concurrently with the other components instead of sequentially.

After the powder or non-powder, or combination of powder and non-powder coating(s) are applied, the coated ice cream particles or units may be optionally conveyed, transported or otherwise transferred by any active or passive means to further processing equipment or storage (see FIG. 2, step 208). The coated ice cream particles or units may also be cooled from the slightly elevated coating temperature (e.g., from about −20° F. to about 0° F. or higher) back down to a storage temperature (e.g., from about −40° F. to about −20° F.), which may be carried out separately or in combination with a subsequent conveying step. This re-cooling step back down to storage-appropriate temperatures may be performed prior to storage of the coated beads or prior to additional coating or other processing steps. According to some embodiments, the reduction in temperature from the coating temperature to the storage temperature should preferably be done gradually (i.e., not quickly or instantaneously) to not disrupt the powder coating.

According to some embodiments, this further processing equipment may include a spray-on and/or a tumbling or mixing coating apparatus as discussed above so that powder coated ice cream particles or units may be mixed with non-powder coated ice cream units or other powder coated ice cream units. The spray-on coating apparatus described above, for example, may be used to produce a candy-like shell around the powder-coated ice cream units. Further processing equipment may also include volumetric fillers and packagers which place the finished products in containers for bulk or retail sale. This additional processing equipment may also include cryogenically cooled components to maintain the low temperature of the ice cream units during the additional processing and handling.

For coated ice cream particles or centers undergoing a subsequent liquid-coating step after an initial powder coating step, the powder coating may act as a binder as well as a heat sink for the liquid coating during its application. In some embodiments, the powder coating may be applied to the ice cream particles in an amount thick enough to enable uniform and continuous surface coverage of the liquid coating, but thin enough such that the powder coating does not dominate the flavor or texture of the final composition of matter when the powder coating flavor is not desired (e.g., from about 400 μm to about 600 μm).

As mentioned, the above processes may produce coated ice cream particles or units which may then be stored, for example, at a temperature from about −40° F. to about −20° F. or, alternatively, in conventional freezers depending on the particular formulation of ice cream being used in production. The thickness of the coating also plays a role in determining the storage temperature since a thicker coating generally provides more protection (e.g., resistance to physical deformation and/or melting) than a thinner coating. The thickness selected for each coating layer is a function of what attributes are desired in the resulting product. The relative taste of each flavor along with the mouth-feel (e.g., texture) of the product all play a role in determining how thick to make a particular coating. Thus, the thickness of the coating may vary from fractions of a millimeter to a few millimeters. For larger ice cream units, the thickness of the coating may even be larger.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with each claim's language, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A composition comprising:
a particulate ice cream food product; and
a powder coating,
wherein the particulate ice cream food product comprises a plurality of cryogenically frozen ice cream particles, and wherein the powder coating is disposed on the surface of the plurality of cryogenically frozen ice cream particles.

2. The composition of claim 1, wherein the ice cream food product comprises an ice cream, ice milk, flavored ice, frozen yogurt or sorbet.

3. The composition of claim 1, wherein the plurality of cryogenically frozen ice cream particles have a free-flowing pourability while frozen at a temperature of about −25° F. for a period of at least 24 hours.

4. The composition of claim 1, wherein the cryogenically frozen ice cream particles have a generally spherical or spheroid shape.

5. The composition of claim 1, wherein the plurality of cryogenically frozen ice cream particles have an average diameter of about 0.05 inch to about 0.5 inch.

6. The composition of claim 1, wherein the formulation of the particulate ice cream food product comprises the following ingredients and ranges of weight percentages: about 1% to about 16% milkfat; about 2% to about 24% serum or non-fat milk solids; and about 1% to about 8% sugar.

7. The composition of claim 6, wherein the formulation of the particulate ice cream food product further comprises one or more of the following ingredients and ranges of weight percentages: about 0.1% to about 0.4% sweetener; about 1% to about 20% bulking agent; about 0.1% to about 1% cryoprotectant; about 0.3% to about 4% stabilizer and/or emulsifier; and/or one or more natural and/or artificial flavors.

8. The composition of claim 1, wherein the particulate ice cream food product has a weight percentage of total solids from about 29% to about 42%.

9. The composition of claim 1, wherein the particulate ice cream food product has a weight percentage of total solids from about 35% to about 42%.

10. The composition of claim 1, wherein the formulation of the particulate ice cream food product comprises about 2% to about 24% serum or non-fat milk solids by weight.

11. The composition of claim 1, wherein the powder coated particulate ice cream food product has a greater free-flowing character or pourability at higher temperatures compared to uncoated particulate ice cream food product of the same formulation.

12. The composition of claim 1, wherein the powder coating comprises one or more of the following: citric acid, probiotic, coffee solids, sugar, cocoa powder, non-nutritive sweeteners, polysaccharides, silicon-based solids, or powdered protein.

13. A method comprising the following steps:
(a) providing a particulate ice cream food product, wherein the particulate ice cream food product comprises a plurality of cryogenically frozen ice cream particles; and
(b) coating the surface of the plurality of cryogenically frozen ice cream particles with a powdered coating by agitation of the ice cream particles in the presence of the powdered coating.

14. The method of claim 13, wherein the plurality of cryogenically frozen ice cream particles provided in step (a) have an average diameter of about 0.05 inch to about 0.5 inch.

15. The method of claim 13, wherein the particulate ice cream food product is provided in step (a) at a temperature of about −40° F. to about −20° F.

16. The method of claim 13, wherein the plurality of cryogenically frozen ice cream particles are warmed to a temperature within a range of at least about −20° F. to about 5° F. during step (b).

17. The method of claim 13, wherein the coating step (b) is performed for a period of time from about 1 minute to about 30 minutes.

18. The method of claim 13, further comprising the step of (c) cooling the coated ice cream particles to a temperature range from about −40° F. to about −20° F., wherein step (c) is performed after step (b).

19. A method comprising the following steps:
(a) cryogenically freezing a particulate ice cream food product to form a plurality of cryogenically frozen ice cream particles; and
(b) coating the surface of the plurality of cryogenically frozen ice cream particles with a powdered coating.

20. The method of claim 19, wherein the formulation of the particulate ice cream food product cryogenically frozen in step (a) comprises the following ingredients and ranges of weight percentages: about 1% to about 16% milkfat; about 2% to about 24% serum or non-fat milk solids; and about 1% to about 8% sugar.
